(19) United States
(12) Patent Application Publication
(10) Pub. No.: US 2014/0146661 A1
(43) Pub. Date: May 29, 2014

(54) METHOD AND APPARATUS FOR FACILITATING PROCESS RESTART IN AN IS-IS SYSTEM

(71) Applicant: TELEFONAKTIEBOLAGET L M ERICSSON (PUBL), (US)

(72) Inventors: Wenhu Lu, San Jose, CA (US); Ing-Wher Chen, McLean, VA (US); Thippanna Hongal, Fremont, CA (US)

(73) Assignee: TELEFONAKTIEBOLAGET L M ERICSSON (PUBL), Stockholm (SE)

(21) Appl. No.: 13/842,133

(22) Filed: Mar. 15, 2013

Related U.S. Application Data
(60) Provisional application No. 61/730,778, filed on Nov. 28, 2012.
(60) Provisional application No. 61/730,784, filed on Nov. 28, 2012.
(60) Provisional application No. 61/730,796, filed on Nov. 28, 2012.

(51) Int. Cl. H04L 12/24

(52) U.S. Cl. CPC H04L 41/06
USPC 370/219

(57) ABSTRACT

A method and apparatus for facilitating process restart in an IS-IS router that includes an active router processor (RP) module for supporting an active IS-IS process instance and standby router processor (RP) module for supporting a standby IS-IS process instance. Routing database information maintained by the active IS-IS process is synchronized to a standby database associated with the standard IS-IS process instance, which is used for synchronizing a new database on the active RP module. When a new instance of the active IS-IS process is restarted on the active RP module, the new instance uses the contents of the new database for continuing to maintain routing functionality.

### PRIORITY UNDER 35 U.S.C. §119(e) & 37 C.F.R. §1.78

This nonprovisional application claims priority based upon the following prior United States provisional patent applications entitled: (i) “IS-IS NON STOP ROUTING COMPLETE SEQUENCE NUMBER PROTOCOL (CSNP) DATA UNIT FOR LINK-STATE PROTOCOL (LSP) DATA UNIT RECOVERY AND GRACEFUL RESTART,” Application No. 61/730,778, filed Nov. 28, 2012, in the name(s) of Wenhu Lu, Thippana Hongal and Ing-Wher Chen; (ii) “IS-IS NON-STOP ROUTING (NSR) RAW LINK-STATE PROTOCOL (LSP) DATA UNIT SYNCHRONIZATION,” Application No. 61/730,784, filed Nov. 28, 2012, in the name(s) of Wenhu Lu, Ing-Wher Chen and Thippana Hongal; and (iii) “METHOD AND APPARATUS FOR NON-STOP ROUTING FOR PROCESS RESTART,” Application No. 61/730,796, filed Nov. 28, 2012, in the name(s) of Wenhu Lu, Ing-Wher Chen and Thippana Hongal; each of which is hereby incorporated by reference in its entirety.

### CROSS-REFERENCE TO RELATED APPLICATION(S)

This application discloses subject matter that is related to the subject matter of the following U.S. patent application(s): (i) “METHOD AND APPARATUS FOR PROTOCOL DATA UNIT RECOVERY IN AN IS-IS SYSTEM” (Ericsson Ref. No.: P38850-US2), application Ser. No. ______, filed ______, in the name(s) of Wenhu Lu, Thippana Hongal and Ing-Wher Chen; (ii) “METHOD AND APPARATUS FOR PROTOCOL DATA UNIT SYNCHRONIZATION IN AN IS-IS SYSTEM” (Ericsson Ref. No.: P38851-US2), application Ser. No. ______, filed ______, in the name(s) of Wenhu Lu, Ing-Wher Chen and Thippana Hongal; and (iii) “METHOD AND APPARATUS FOR FACILITATING PROCESS RESTART IN A MULTI-INSTANCE IS-IS SYSTEM” (Ericsson Ref. No.: P40160-US1), application Ser. No. ______, filed ______, in the name(s) of Wenhu Lu, Ing-Wher Chen and Thippana Hongal; each of which is hereby incorporated by reference in its entirety.

### FIELD OF THE DISCLOSURE

The present disclosure generally relates to network routing protocol technologies. More particularly, and not by way of any limitation, the present disclosure is directed to a method and apparatus for facilitating process restart in an Intermediate System-Intermediate System (IS-IS) router operable in an IS-IS routing network.

### BACKGROUND

An IS-IS router referred to herein has, among its many functionalities, an ability to generate link state protocol data units (LSPs) to describe the routers and links to which it is connected. The information regarding the connected routers and links may be received from other modules in the router, such as physical ports.

Typically, a standby router module and an active router module may be provided as part of the IS-IS router in order to facilitate the capability referred to as Non Stop Routing (NSR). To support NSR capability, databases used for routing must be synchronized between the standby and active router modules so that when the standby router module becomes active, it has a complete database to function seamlessly. In addition, if a router process executing on the active router module restarts for some reason, such a condition should be as transparent as possible so that any network disruption is minimized.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example IS-IS network environment or domain wherein one or more embodiments of the present patent disclosure may be practiced;

FIG. 2 depicts a block diagram of an IS-IS router system according to an embodiment of the present patent disclosure;

FIG. 3 depicts a block diagram of a simplified version of an IS-IS router that implements a database synchronization mechanism for facilitating process restart according one embodiment;

FIGS. 4A and 4B depict flowcharts pertaining to sequences of events that may occur according to an embodiment of a process restart mechanism of the present patent disclosure;

FIG. 5 depicts a block diagram of a simplified version of another IS-IS router that implements a database synchronization mechanism for facilitating process restart according an alternative embodiment; and

FIGS. 6A and 6B depict flowcharts pertaining to sequences of events that may occur according to an alternative embodiment of a process restart mechanism of the present patent disclosure.

### DETAILED DESCRIPTION OF THE DRAWINGS

The present patent disclosure is broadly directed to a method and apparatus for facilitating process restart in an IS-IS router having redundancy for purposes of effectuating Non Stop Routing. The present patent disclosure is also directed to associated computer-accessible media, computer programmable products and various software/firmware components relative to the process restart and associated database synchronization techniques set forth herein.

In one aspect, an embodiment of a method of facilitating process restart performed in a network element operating as an IS-IS router is disclosed, wherein the IS-IS router may comprise an active route processor (RP) module and a standby route processor (RP) module. The claimed embodiment comprises, inter alia, initiating an active IS-IS process on the active RP module for providing routing functionality, the active IS-IS process maintaining a first database associated with the active RP module with respect to the routing functionality, and initiating a standby IS-IS process on the standby RP module having a second database associated therewith, wherein the second database is populated based on synchronization with the first database. The claimed embodiment further includes restarting a new instance of the active IS-IS process on the active RP module, responsive to a control signal (e.g., a command input or a failure condition encountered by the active IS-IS process), and populating a new database associated with the new instance that is based on synchronization with the second database of the standby IS-IS process for continuing to provide the routing functionality. In another aspect, an embodiment of a non-transitory computer-readable medium containing instructions stored thereon is disclosed. When the stored instructions are executed by a computer system configured to operate as an IS-IS router, the computer system is operable to perform an embodiment of the method set forth above.

In a still further aspect, an embodiment of a network element configured to operate as an IS-IS router is disclosed. The claimed embodiment comprises, inter alia, an active RP module supporting an active IS-IS routing process based on a first link state database, and a standby route processor (RP) module supporting a standby IS-IS process associated with a second link state database. The claimed network element also includes a first synchronization module configured to facilitate synchronization of the first database of the active IS-IS process with the second database of the standby IS-IS process, and a second synchronization module configured to facilitate synchronization of the second database of the standby IS-IS process with a new database on the active RP module when a new instance of the active IS-IS process is restarted on the active RP module responsive to a control signal. The new instance of the active IS-IS process preferably uses the contents of the new database for continuing to maintain routing by the network element. In a further variation, the first and second synchronization modules may be integrated as an inter-process communication module disposed between the active and standby RP modules or platforms.

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that the embodiments of the present disclosure may be practiced without such specific details. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

As used herein, a network element (e.g., a router, switch, bridge, etc.) is a piece of networking equipment, including hardware and software that communicatively interconnects other equipment on a network (e.g., other network elements, end stations, etc.). Some network elements may comprise “multiple services network elements” that provide support for multiple networking functions (e.g., routing, bridging, switching, Layer-2 aggregation, session border control, Quality of Service, and/or subscriber management, and the like), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VOIP) phones, user equipment, terminals, portable media players, GPS units, gaming systems, set-top boxes) may access or consume content/services provided over a packet-switched wide area public network such as the Internet via suitable service provider access networks. Subscriber end stations may also access or consume content/services provided on virtual private networks (VPNs) overlaid on (e.g., tunneled through) the Internet. It should be appreciated that one or more embodiments of the present patent disclosure involving IS-IS routing protocol functionality may be implemented in such arrangements wherein the content and/or services are typically provided by one or more end stations (e.g., server end stations) belonging to a service or content provider. Alternatively or additionally, content and/or services may be consumed among the end stations participating in a peer-to-peer service, and may include, for example, public webpages (e.g., free content, online store fronts, search services, etc.), private webpages (e.g., username/password accessed webpages providing email services), and/or corporate networks over VPNs. Typically, subscriber end stations may be coupled (e.g., through customer premise equipment or CPE coupled to an access network (wired or wirelessly)) to edge network elements, which are coupled (e.g., through one or more core network elements) to other edge network elements, which are coupled to other end stations (e.g., server end stations).

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices (e.g., an end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such electronic devices may typically include a set of one or more processors coupled to one or more other components, such as one or more storage devices (non-transitory machine-readable storage media), user input/output devices (e.g., a keyboard, a touch screen, a pointing device, and/or a display), and network connections. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device may be configured to store code and/or data for execution on one or more processors of that electronic device for purposes of implementing one or more techniques of the present disclosure.

By way of example, embodiments of the present patent disclosure will be described below in detail by taking reference to a router network based at least on the Intermediate System-to-Intermediate System (IS-IS) routing protocol. Further, where routers adapted to operate with multiple routing protocols are disposed in the network, additional routing protocols may also be provided as part of the router software that is componentized such that if a router's functionality relative to one routing protocol is diminished or otherwise impaired, the router may continue to operate using the other routing protocols.

The IS-IS routing protocol, which is standardized according to the ISO/IEC 10589 specification, incorporated by reference herein, is a link-state protocol similar to Open Shortest Path First (OSPF) routing protocol. As is known, a link-state routing protocol is one of the two main classes of routing protocols used in packet-switching networks for communications, the other being the distance-vector routing protocol. Both OSPF and IS-IS are examples of an Interior Gateway Protocol (IGP) that may be used for routing information within a domain or autonomous system (AS). In contrast, an Exterior Gateway Protocol (EGP) may be used for determining network reachability between autonomous systems and makes use of IGPs to resolve routes within an AS.

In a link-state routing protocol based network, each switching node (i.e., nodes or elements that are configured to forward packets, also known as routers) constructs a map of the connectivity of the network, in the form of a graph, showing which nodes are connected to which other nodes. Each node then independently calculates the best paths from that node to every possible destination in the network (e.g., using Dijkstra's algorithm), the collection of which forms the node's routing table or database.

To achieve scalability as well as simplify router design and operation, a hierarchical routing architecture may be utilized in a routing network. For example, a domain or AS—which is a portion of the network that may be under a common administrative authority—may be organized such that one or more areas may be defined within the domain or AS. In general, an area may be a logical entity that is comprised of a set of contiguous routers and the data links that connect them. All routers in the same area exchange information about all the hosts or End Systems (ESs) they can reach. The areas of an AS or domain are connected to form a backbone, wherein the routers have the information how to reach all areas.

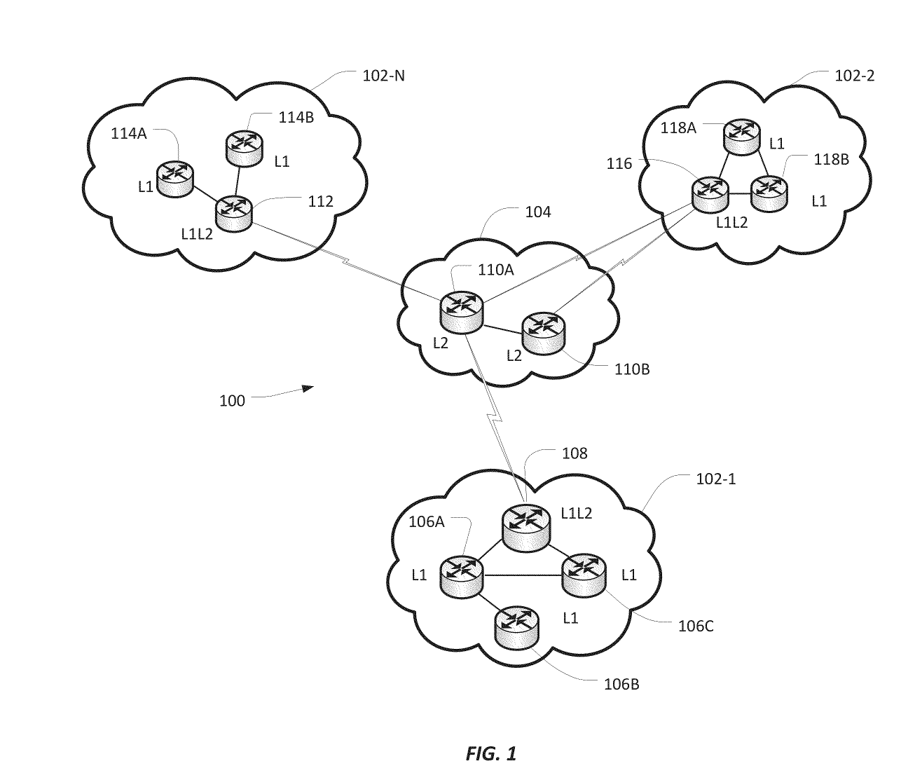

Routers that can communicate within the same area are designated as Level 1 (L1) routers. Routers that form the backbone and have the information to reach other areas are designated as Level 2 (L2) routers. Some routers may be configured to operate as both L1 and L2 routers (L1L2) and may therefore be provided with routing databases specific to both intra-area and inter-area routing. Referring now to the drawings and more particularly to FIG. 1, depicted therein is an example IS-IS network environment or domain 100 comprising a plurality of areas 102-1 to 102-N that are coupled to a backbone 104, wherein an IS-IS router (or, simply an IS router) may be advantageously implemented according to one or more embodiments of the present patent disclosure. By way of illustration, the backbone 104 is comprised of two L2 routers 110A and 110B that are interconnected. Each area is coupled to the backbone 104 via a single L1L2 router within the area. For instance, area 102-1 includes three L1 routers 106A-106C and an L1L2 router 108 that is connected to L2 router 110A of the backbone 104. In similar fashion, area 102-2 includes two L1 routers 118A-118B and an L1L2 router 116 that is connected to both L2 router 110A and L2 router 110B, and area 102-N includes two L1 routers 114A-114B and an L1L2 router 112 that is connected to L2 router 110A.

For purposes of effectuating an operative routing network, each of the IS-IS routers engages in appropriate data exchange processes and maintains a number of databases that can be arranged in any known or heretofore unknown architectures. A unit of data, defined as a protocol data unit (PDU), may be regarded as a packet that is used for exchange of data. Four general types of packets exist, depending on the function of the PDU. A Link State Protocol Data Unit (LSP) is used for distributing link state information relative to the physical links (e.g., broadcast or point-to-point links) supported by the routers of the network. An IS-IS Hello (IIH) PDU is used for establishing and maintaining neighbor relationships (i.e., adjacencies) among the routers of the network, wherein an adjacency refers to a relationship between two IS-IS routers if they can perform a two-way communication with each other. Special PDUs known as Sequence Number PDUs (SNPs) may be used for purposes of link state database synchronization among the IS-IS routers. A Partial Sequence Number PDU (PSNP) is used to acknowledge and request link state information among the routers. A Complete Sequence Number PDU (CSNP) is used to describe a router's complete link state database. Depending on the size of a link state database associated with an IS-IS router, more than one CSNP may be needed to transmit the entire contents of the link state database in certain implementations.

Because of the hierarchical routing architecture of an IS-IS network, such as the network 100 exemplified in FIG. 1, each of the foregoing packets or PDUs can be designated as Level 1 or Level 2 packets and may be used by a router of a particular level for purposes of exchanging data and populating suitable routing databases. A Level 1 (L1) router (e.g., L1 106A in area 102-1) knows the topology of its own area (i.e., it has neighbors only within the same area) and therefore maintains Level 1 databases (e.g., one or more Level 1 link state databases and one or more Level 1 forwarding databases), collectively comprising a routing information database, as well as a Level 1 adjacency database for effectuating intra-area routing. An L1 router may have both L1 and L1/L2 neighbors in its area, however. In similar fashion, a Level 2 (L2) router (e.g., L2 110A) may have neighbors in the same area or other areas and maintains Level 2 databases for effectuating inter-area routing. An L1L2 router (e.g., L1L2 108), on the other hand, maintains separate Level 1 databases (for intra-area routing) as well as Level 2 databases (for inter-area routing).

After the IIH PDUs are exchanged and adjacencies are established in the IS-IS network, LSPs may be transmitted by the routers on all known links or interfaces (i.e., flooding) to exchange network topology information. In general, LSPs have a fixed header and one or more variable length content fields that are encoded using Type, Length and Value (TLV) coding. The fixed header may contain the PDU type/length, the LSP ID and sequence number, checksum, hierarchical level of the LSP (i.e., L1 or L2), among others. The TLV-coded contents may comprise the issuing IS router's area addresses, neighbor IS routers, neighbor ES routers, authentication information, etc.

To support enhanced functionalities such as Non Stop Routing (NSR), Stateful Switch Over (SSO), In-Service Software Upgrades (ISSU), and the like, any of the IS-IS routers exemplified in the IS-IS network 100 of FIG. 1 may be architected with redundancy, e.g., using separate processing hardware platforms or modules (each having one or more processors and associated memory coupled thereto in a suitable bus architecture), whereby an IS-IS routing process involving generation and propagation of the link state information and computation of routes using the link state information (i.e., the control plane) can be provisioned to be executed on the separate hardware platforms. It should be recognized that in some implementations, the individual hardware platforms may be co-located or otherwise integrated into a network element or node. In other implementations, the hardware platforms may be provided as distributed equipment that logically functions as a single network node. Regardless of any specific implementation, when a redundancy architecture having multiple instances of the IS-IS routing process is utilized for an IS router implementation, typically only one of the instances of the IS-IS process executing on the associated hardware platform may be active at any one time, the remaining instances and corresponding hardware platforms being “inactive” or “dormant” (i.e., in a standby mode). Furthermore, the router databases may also be redundantly provisioned or at least logically partitioned such that each standby instance of the IS-IS routing process has a separate database copy associated therewith, which is updated or synchronized based on the database(s) associated with the active IS-IS routing process that typically maintains the most up-to-date or accurate contents (e.g., link state information, forwarding data, adjacency data, etc.).

It should be appreciated that in order to support enhanced functionality such as, e.g., NSR, SSO, etc., the database(s) of a standby IS-IS hardware platform (which may be referred to as a route processor (RP) module) associated with an inactive IS-IS routing process must be maintained as current as possible relative to the database(s) of the active RP module executing the active IS-IS routing process, should it be necessary for any reason that the active IS-IS routing process cease its control plane execution and an inactive IS-IS routing process on the standby RP module take over the control. For example, to provide Non Stop Routing in a failover or in an operator-induced switchover scenario, the link state database of the active RP module (or, more generally an active router) must be accurately synchronized to the database(s) of the standby RP module (or, more generally a standby router) so that when the standby IS-IS router becomes the active IS-IS router, the active IS-IS router has a complete database to function seamlessly.

Those skilled in the art will recognize upon reference hereto that an IS-IS router architected with redundancy may be deployed to include a system of two or more RP modules, at least one of which is in an active mode and the remaining being in a standby mode. Accordingly, references to an “active IS-IS router” may mean an active RP module and references to a “standby IS-IS router” may mean a standby RP module in certain embodiments for purposes of the present patent disclosure.

Regardless of the approach used to synchronize the link state database(s), both local LSPs (i.e., LSPs generated by an RP module of the IS-IS router and remote LSPs (i.e., LSPs originated by other IS-IS routers) received by the IS-IS router must be synchronized between the active and standby RP modules in order to facilitate NSR. Typically, the local LSPs may be generated by an active RP module supporting an active IS-IS process based on the control information, status information, configuration data or updates thereof received from various hardware/software modules associated with the active RP module, including, e.g., line cards, ports, link interfaces, etc. Adding NSR functionality implies that when a standby RP module and the standby IS-IS process supported thereon are activated to become the new active RP module, the new active IS-IS process must also eventually generate LSPs describing the IS-IS router's link states based on the contents of its link state database. Furthermore, if a local LSP generated by the new active RP module is identical to the one generated by the old active RP module of the IS-IS router, that is, it has an identical checksum, then it would be preferable if the sequence number of such a local LSP remains the same and is handled in such a way that the switchover from the old active RP module to the new active RP module of the IS-IS router is transparent to neighboring routers. Clearly, accomplishing such a task requires certain link state data to be on or otherwise available to the standby RP module prior to it becoming the new active RP module of the IS-IS router. Likewise, remote LSPs received from the adjacent routers by the active RP module of the router (which contain the sending/originating router's internal information including its own link state data) are also required to be synchronized to the standby RP module's database.

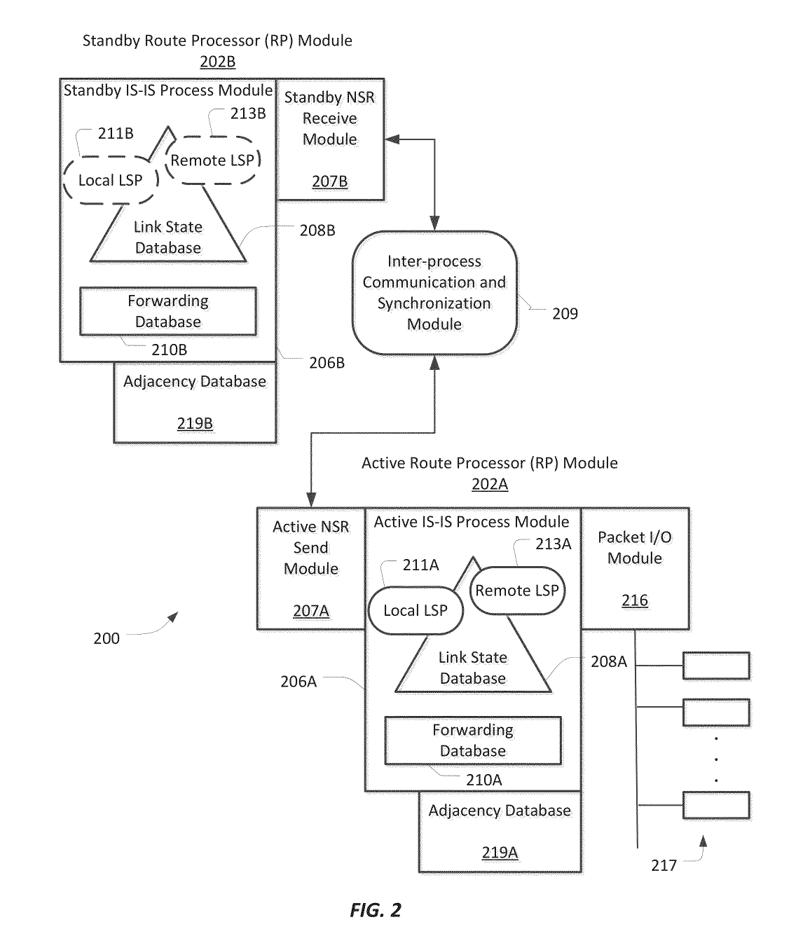

Taking reference to FIG. 2, depicted therein is a logical block diagram of a network element 200 that is capable of operating as an IS-IS router having redundancy wherein both local and remote LSPs may be synchronized between the active and standby platforms for purposes of the present patent disclosure. It should be apparent that the network element 200 may be configured to function as a physical router system in an L1, L2 or L1/L2 hierarchy according to the IS-IS specification, and may illustrate a particular implementation of any of the IS-IS routers of the network 100 of FIG. 1 described hereinabove. By way of example, a single active RP module 202A (which may form a computer platform or a portion thereof) supporting an active IS-IS routing process instance or module 206A and a single standby RP module (which may form another computer platform or a portion thereof) 202B supporting an inactive IS-IS routing process instance or module 206B are provided as part of the network element 200. Associated with the existing or current active IS-IS routing process module 206A are the active routing databases, e.g., a first link state database 208A and a first forwarding database 210A, which together form a routing information base (RIB) of the active IS-IS process module 206A. In similar fashion, the existing or current inactive IS-IS routing process module 206B is supported by its databases, e.g., a second link state database 208B and a second forwarding database 210B which form a RIB of the standby IS-IS process module 206B. Each RP module may also be provided with an adjacency database 219A, 219B, although they may comprise a single database with suitable database partitioning in alternative embodiments. A packet input/output (I/O) module 216 is adapted to forward IS-IS packets to appropriate destinations based on subnetwork dependent and/or subnetwork independent functions. Reference numeral 217 generally refers to an assortment of example hardware modules or subsystems (e.g., line cards, ports, link interfaces, etc.) associated with the active RP module 202A that can generate various pieces of control information, configuration data, status information as well as corresponding updates, which may be processed by the active IS-IS process module 206A for updating its link state database as will be described in further detail below. It will be apparent to one skilled in the art that the same or similar hardware modules and subsystems may also be operatively associated with the standby RP module 202B such that when the standby RP module is activated, the subsystems will be under its operational control.

The link data base 208A associated with the active IS-IS process module 206A may be partitioned into separate database portions, e.g., one for storing and maintaining local LSPs and the other for storing and maintaining remote LSPs received from other routers. Reference numeral 211A refers to a first local LSP database portion wherein the locally generated LSPs are stored that may be refreshed or updated based on the configuration data inputs received from the modules 217. Reference numeral 213A refers to a first remote LSP database portion for storing the remote LSPs received from adjacent routers. As these remote LSPs are originated by other routers, which also operate according the IS-IS specification, the remote LSPs contain remote routers' information (link states and other data internal to the remote routers) encoded in the packet format specified by the IS-IS specification. The active IS-IS process module 206A therefore receives the remote LSPs in a raw LSP packet format according to the IS-IS specification, which are stored in the first remote LSP database portion 213A. One skilled in the art will recognize that the raw LSPs received from a remote router are in a format identical to that of the local LSPs generated and flooded to other routers, but contain different information describing the link state data of the originating remote router.

Similar to the active link state database 208A associated with the active IS-IS process module 206A, the standby or second link state database 208B associated with the standby IS-IS process module 206B may also be partitioned into separate local LSP and remote LSP database portions. Reference numerals 211B and 213B refer to example second local LSP and second remote LSP database portions, which are referred to herein as “second” database portions solely to distinguish from the corresponding database portions of the active or first link data base 208A. Although the standby IS-IS process module 206B is in a standby or inactive mode with respect to the control plane of the IS-IS router 200, it may be configured to perform certain limited functions in the “background,” and may therefore receive configuration data inputs from the modules within the router as well. Accordingly, in one example implementation, such data may be used by the standby IS-IS process module 206B to generate, refresh or otherwise update its own local LSPs. Regardless of whether the standby IS-IS process module 206B generates its own local LSPS, the second local LSP and second remote LSP database portions 211B, 213B may be synchronized to the corresponding first local LSP and first remote LSP database portions 211A, 213A, mediated by way of an inter-process communication and synchronization module 209 operatively coupled between the active (i.e., first) and standby (i.e., second) IS-IS process modules 206A, 206B. To facilitate such inter-process communication functionality for effectuating LSP database synchronization, an Active NSR Send module 207A interfaced with the active IS-IS process module 206A may be provided as part of the active RP module 202A and a Standby NSR Receive module 207B interfaced with the standby IS-IS process module 206B may be provided as part of the standby RP module 202B, wherein the inter-process communication module 209 is disposed in a communication relationship with both modules 207A, 207B.

As alluded to previously, a network element such as the IS-IS router system 200 described above may also include additional hardware/software platforms, suitably componentized to perform in accordance with additional routing protocols, e.g., the OSPF routing protocol. Such additional routing protocol functionalities may also be redundantly architected similar to the redundant IS-IS architecture set forth herein. To facilitate the NSR capability in more than one routing protocol, database synchronizations specific to a particular routing protocol from the corresponding active platform to the corresponding standby platform may need to take place. It will be recognized that whereas the inter-platform NSR capability is advantageous when a complete switchover is desired, it would be inefficient to do so for minor problems that may be encountered by the router system 200. In other words, there can be a class of failure/error modes for which a full switchover from the active platform to the standby platform of the router 200 is unnecessary. For example, the active IS-IS process instance 206A executing on the active RP module 202A crashes, just “hangs,” or otherwise becomes inoperative, one or more techniques of the present patent disclosure provide for restarting another instance of the IS-IS process on the same active RP module 206A without affecting other components/modules thereof in order to render the IS-IS router 200 more resilient and robust. In such a design, for example, one software component may be responsible for performing the IS-IS routing protocol specification whereas another software component may be responsible for performing the OSPF specification, and when the IS-IS process on the active RP module 202A crashes, the active RP module 202A does not need to shut down to force a switchover to the standby RP module 202B because such an event is not a catastrophic event and the OSPF process can subsequently continue to perform the OSPF routing protocol without interruptions on the active RP module 202A.

It should be appreciated that various protocol-specific databases need to be readily available to a new instance of the process being restarted so that the process restarting mechanism is effectuated in a seamless and transparent manner, i.e., preferably without the neighboring routers detecting any interruptions and thereby causing disruptions in the routing network. Accordingly, routing database information such as link state data (including the local LSP and remote LSP data described in detail above) as well as adjacency data should be made available to the restarting process as efficiently as possible. The present patent disclosure sets forth below one or more embodiments wherein the routing database information that may be synchronized to a standby platform as described above can also be advantageously “synchronized back” to the active RP module so that a new instance of the restarting process can have a fairly complete database to calculate routes and to communicate with the neighbors based on established adjacencies.

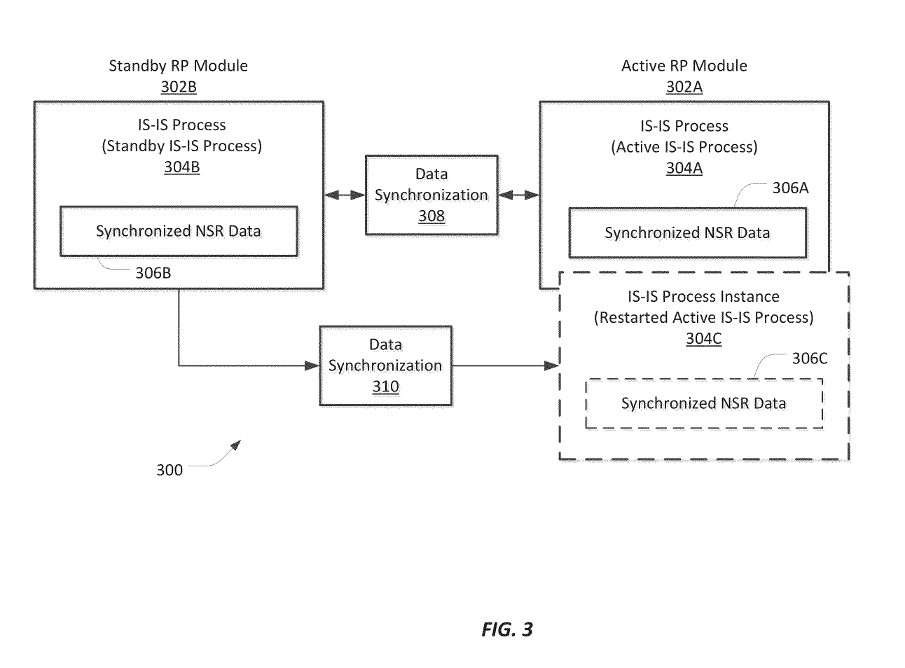

FIG. 3 depicts a block diagram of a simplified version of an IS-IS router 300 that implements a database synchronization mechanism for facilitating process restart according one embodiment. Consistent with the description of a redundancy IS-IS router architecture set forth above, an active RP module 302A may be adapted to execute an instance or thread of an IS-IS process in active mode, i.e., active IS-IS process instance 304A. Associated with the active IS-IS process instance 304A is a first database 306A, referred to as a “synchronized NSR database” herein, for purposes of effectuating the routing functionality of the IS-IS router 300. The synchronized NSR database 306A may be broadly treated as a consolidated representation of the various databases such as the link state database 208A (including the local and remote LSP database portions 211A, 213A), forwarding database 210A and adjacency database 219A illustrated with respect to the active RP module 202A shown in FIG. 2. Likewise, a standby RP module 302B is adapted to host a standby IS-IS process instance or thread 304B based on a redundantly maintained synchronized NSR database 306B (i.e., a second database). A first synchronization module, e.g., data synchronization module 308, is operatively disposed between the active and standby RP modules 302A, 302B such that there is synchronization between the two synchronized NSR databases 306A, 306B for purposes of facilitating the NSR capability in the event of an inter-platform switchover. It should be appreciated that although the second database 306B is illustratively associated with the standby RP module 302B, such a “standby” database may in one embodiment reside in a memory space associated with the active RP module 302A (where the first database may also be located), with appropriate database partitioning, segmenting, etc.

When the active IS-IS process instance 304A is required to restart for any reason, the active RP module 302A may be configured to initiate a new active IS-IS process instance 304C as a “new incarnation” of the active IS-IS process 304A that is no longer in control. To operationalize the new active IS-IS process instance 304C for continuing to provide routing functionality, a new database 306C associated therewith may be populated based on a second synchronization module, e.g., data synchronization module 310, that is operatively disposed between the two RP modules. When synchronization from the standby database 306B to the new database 306C is complete (which may be referred to as “reverse synchronization” in contrast to the synchronization process effectuated by the first data synchronization module 308, i.e., “forward synchronization”), the new active IS-IS process instance 304C will have access to the most recently synchronized copy of the adjacency database along with the state data that can be used to compute the routes and communicate with the neighbors without requiring a Graceful Restart procedure to be performed.

Those skilled in the art will recognize that in an example implementation the forward data synchronization module 308 may be configured to synchronize both local LSPs as well as remote LSPs between the active and standby databases 306A, 306B in accordance with the teachings set forth hereinabove. Likewise, the reverse data synchronization module 310 may be configured to synchronize the local LSPs and remote LSPs from the standby database 306B to the new database 306C associated with the new IS-IS process instance 304C. However, it is not necessary that either the forward or the reverse synchronization process be implemented in that manner, and either or both of the processes may include only partial database synchronization involving piecemeal contents in some instances. It should therefore be appreciated that the two synchronization mechanisms may encompass a number of variations or embodiments for purposes of the present patent disclosure. Moreover, the functionalities relating to NSR capability as well as both forward and reverse database synchronization 308, 310 may be advantageously grouped into one or more logical blocks in one example implementation, such as, e.g., inter-process communication/synchronization module 209, that is operable in conjunction with modules 207A and 207B described hereinabove in particular reference to FIG. 2, and may comprise suitable hardware and/or software including storage media having computer-executable instructions.

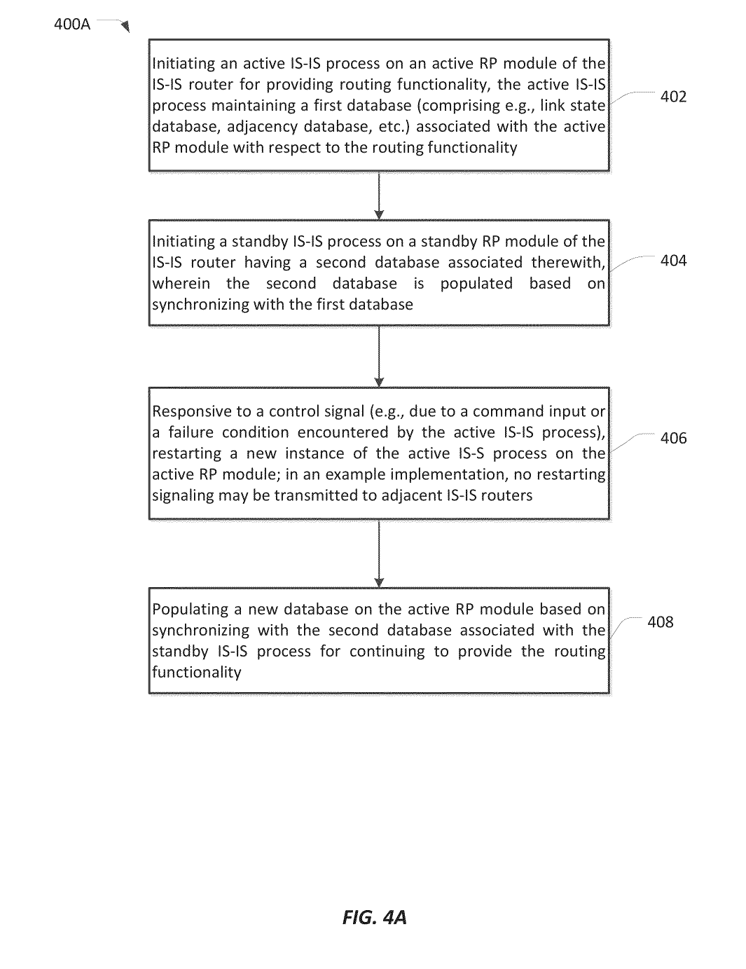

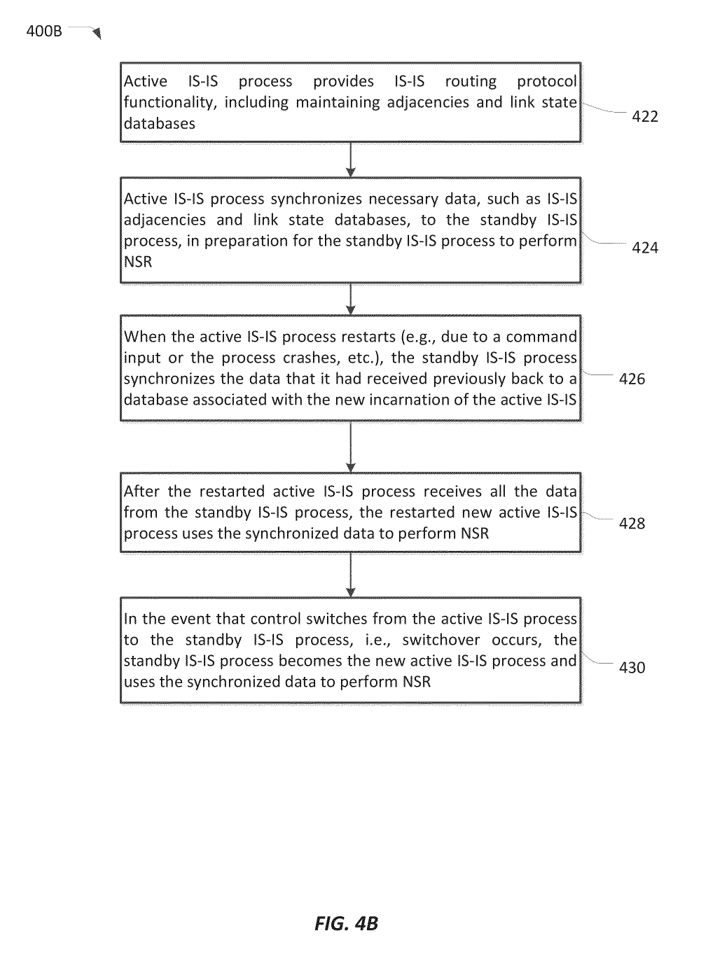

FIGS. 4A and 4B depict flowcharts pertaining to sequences of events that may occur according to an embodiment of a process restart mechanism of the present patent disclosure. Reference numeral 400A in FIG. 4A generally refers to a process that may be performed preferably in a network element operating as an IS-IS router having active and standby RP modules as described above in reference to FIGS. 2 and 3. An active IS-IS process may be initiated, instantiated or executed on the active RP module for providing routing functionality, in a componentized software environment using any known software process architecture or model, e.g., multiprocessing or multithreaded programming. As discussed above, the active IS-IS process or instance may maintain its own database (e.g., a first database) on the hardware platform it is running on, i.e., associated with the active RP module, with respect to the routing functionality. These functionalities are consolidated as block 402 in the process embodiment 400A depicted in FIG. 4A. In order to facilitate NSR, a standby IS-IS process may be initiated, instantiated or executed on the standby RP module that supports a second database associated therewith, wherein the second database may be populated based on synchronizing with the first database of the active process (block 404). Responsive to a control signal, e.g., due to a command input or a failure condition encountered by the active process, or both, a new instance of the active process is restarted on the active RP module without generating and transmitting any restarting signals or help requests to the network element's neighbors (block 406). A new database associated with the new instance may be populated based on synchronization with the second database of the standby IS-IS process for continuing to provide the routing functionality (block 408).

FIG. 4B depicts another variation of a process restart mechanism 400B that illustrates additional acts, steps, functions, components or blocks that may be augmented within process 400A described above. Blocks 422 and 424 comprise functionalities that are roughly similar to the functionalities set forth at blocks 402 and 404 described above, although blocks 422 and 424 provide for maintaining specific database components such as adjacencies as well as link state databases relative to the active and standby IS-IS processes. When the active process restarts, the standby process synchronizes the data that it had previously received back to a database associated with the new active IS-IS incarnation (block 426). After the restarted active IS-IS process receives all the necessary data from the standby process, the new restarted active process uses the synchronized data to perform NSR (block 428). In the event that the control plane of the router is switched over to the standby platform, i.e., the standby IS-IS process takes over the execution of the control plane, the standby IS-IS process becomes the new active IS-IS process and uses the data previously synchronized to perform NSR (430). It should be appreciated that the capability of NSR may be provided in this variation under both modes of failure (e.g., software errors affecting a current active IS-IS process instance or more serious hardware errors that render the entire active RP platform inoperative).

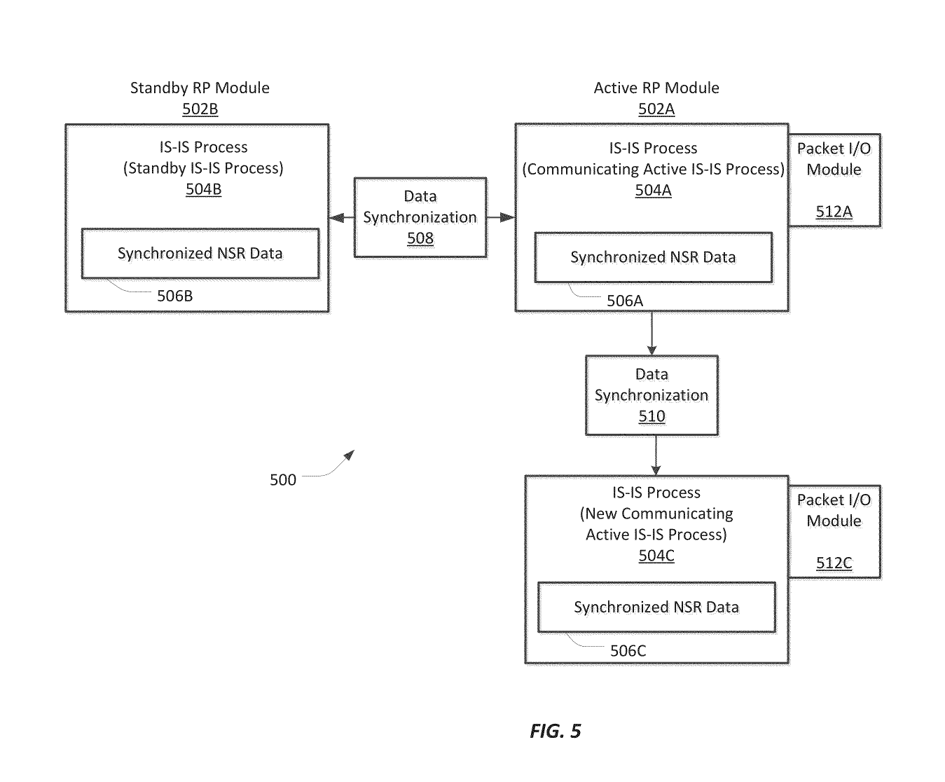

FIG. 5 depicts a block diagram of a simplified version of another IS-IS router 500 that implements a database synchronization mechanism for facilitating process restart according to an alternative embodiment of the present patent disclosure. In a design where the software component that provides the IS-IS routing protocol functionality is run as a process and where multiple such processes can be created simultaneously, several IS-IS processes may be created on an active RP module, e.g., as separate instances or threads. In such a configuration, only one of the IS-IS processes or instances may be designated as the communicating active process whereas the remaining instances of the active process are in a dormant mode. By way of illustration, active RP module 502A of the router 500 may be configured to support multiple active IS-IS process instances 504A, 504C, wherein the process instance 504A is designated as the communicating active process (i.e., one that is actually performing packet I/O communications with external neighbors to establish adjacencies and exchange link state database information). A packet I/O module 512A may therefore be separately provided for such communications. The communicating active IS-IS process instance 504A may be configured to synchronize its NSR data 506A necessary for routing to other replicated but dormant IS-IS process instance(s) 504C on the active RP module 502A, such that the replicated but dormant IS-IS process(es) 504C may have the data in associated database(s) 506C to perform NSR later. One or more data synchronization modules 510 may be provided to effectuate such an intra-platform synchronization. At the same time, the example implementation might also contain a standby RP module 502B for supporting a standby IS-IS process 504B. Similar to the router embodiments of FIGS. 2 and 3, the communicating active IS-IS process instance 504A can also synchronize its routing data 506A to the standby IS-IS process 504B using an inter-process communication/synchronization module 508 such that when control switches from the active RP module 502A to the standby RP module 502B, the standby IS-IS process 504B has the necessary data in an database 506B associated therewith to take over the routing functions.

Moreover, similar to the synchronization mechanisms relative to the embodiments depicted in FIGS. 2 and 3, data synchronization modules 508, 510 may be configured to synchronize both local and remote LSPs as well as the forwarding and adjacency database contents across the platform and within the platform so as to facilitate both inter-platform and intra-platform NSR. In the event that the communicating active IS-IS process instance 504A crashes, the replicated IS-IS process instance 504C can immediately take over the control plane and effectuate suitable packet I/O communications to become the new communicating active IS-IS process instance. The new communicating active IS-IS process instance 504C preferably uses the synchronized NSR data 506C to continue to perform the IS-IS routing protocol functionality, using a packet I/O module 512C associated therewith in an example implementation. It should be realized that unlike the process restart embodiment illustrated in FIG. 3, this approach eliminates the time needed for the NSR data to be synchronized back to the active RP platform 502A from the standby process 504B supported on the standby RP platform 502B.

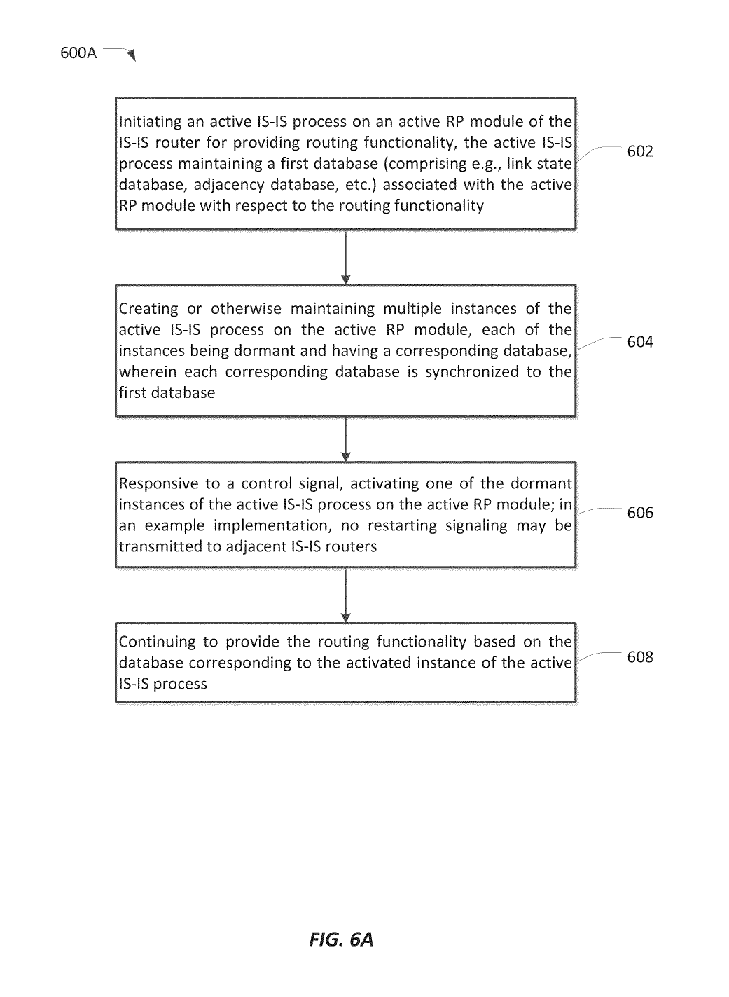

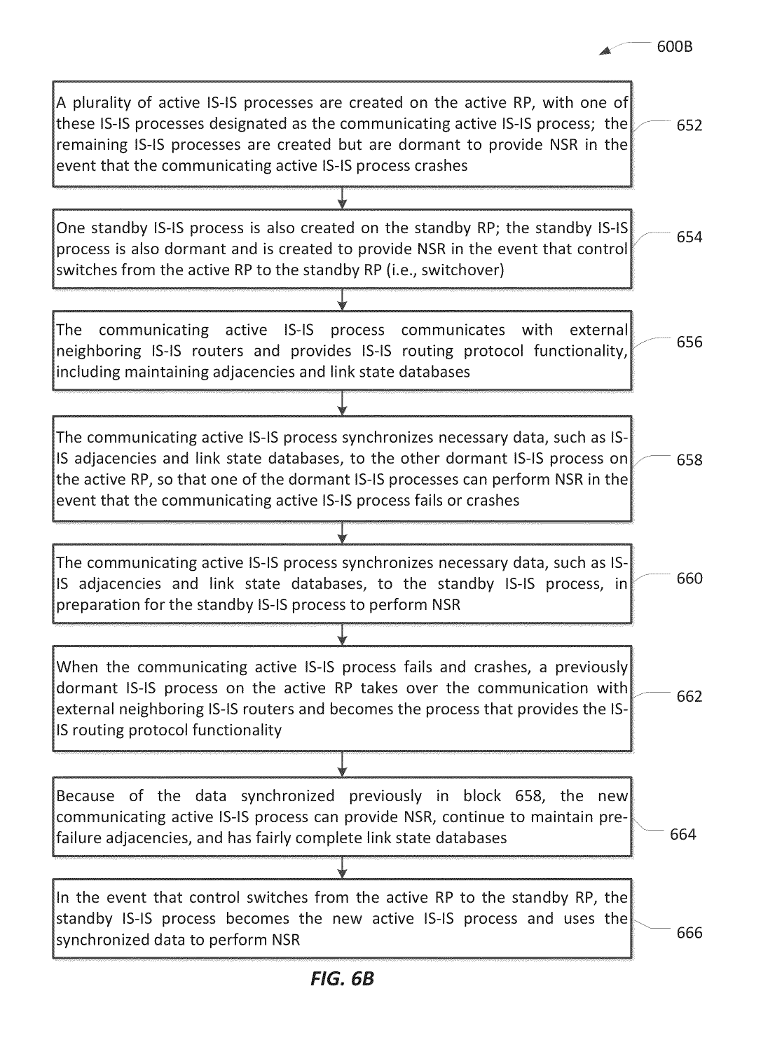

FIGS. 6A and 6B depict flowcharts pertaining to sequences of events that may occur according to a process restart mechanism according to the alternative embodiment set forth above. Reference numeral 600A in FIG. 6A generally refers to a process that may be performed in a network element operating as an IS-IS router having active and standby RP modules as described above in reference to FIGS. 2 and 5, although it is not necessary that such a redundant architecture be provided as part of the router. An active IS-IS process may be initiated, instantiated or commenced to execute on the active RP module for providing routing functionality, wherein the active IS-IS process maintains a first database associated with the active RP module with respect to the routing functionality (block 602). Multiple instances of the active IS-IS process may also be created on the active RP module, each of the instances being dormant (i.e., non-communicating). Although dormant, each non-communicating instance of the active IS-IS process is provided with its own corresponding database that is synchronized (block 604) from the active database of the communicating IS-IS instance created in block 602. Responsive to a control signal (e.g., a command signal input or a failure condition encountered by the communicating active IS-IS process instance, or both), one of the dormant instances of the active IS-IS process may be activated to become the new communicating process (block 606). As before, no restarting signaling or help requests may need to be transmitted to the adjacent routers. The new communicating IS-IS process instance is configured to continue to provide the routing functionality based on the new database associated therewith (block 608) for purposes of NSR.

FIG. 6B depicts another variation of a process restart mechanism 600B that illustrates additional acts, steps, functions, components or blocks that may be augmented within process 600A described above. Block 652 comprises functionalities that are roughly similar to the functionalities set forth at blocks 602 and 604 described above, wherein more than one IS-IS process are created on an active RP module, with one of the multiple process instances being designated as a communicating active IS-IS process instance. If the system has a standby RP platform or module, a single standby IS-IS process may also be created on the standby RP module (block 654). The communicating active IS-IS process instance is operable to communicate with external neighboring IS-IS routers and therefore provides the IS-IS routing protocol functionality by maintaining adjacencies and building suitable link state databases (block 656). In addition to providing the IS-IS routing protocol functionality, the communicating active IS-IS process/instance also synchronizes data in preparation for NSR to the dormant IS-IS processes/instances on the active RP platform (block 658) and to the standby IS-IS process, if exists (block 660). In the event that the communicating active IS-IS process instance fails, one of the dormant IS-IS process instances on the active RP platform immediately takes up control of communication with external neighboring IS-IS routers based on a suitable selection, election, designation or arbitration mechanism (block 662), which can then use the data synchronized in block 658 to perform NSR (block 664). Pre-failure adjacencies can be maintained and the state of the link state databases is expected to be very up-to-date, whereby only minimal disruptions may be experienced. In the event that a switchover occurs, i.e., control switches from the active RP platform to the standby RP platform in an example redundancy implementation, the standby IS-IS process becomes the new active IS-IS process and uses the previously synchronized data in block 654 to perform NSR (block 666). It should be appreciated that similar to the embodiment of FIG. 4B, the capability of NSR may also be provided in this variation under different modes of failure.

One skilled in the art will recognize that the order or sequence of the acts, steps, functions, components or blocks illustrated in any of the flowcharts depicted in FIG. 4A-4B or 6A-6B may be modified, altered, replaced, customized or otherwise rearranged within a particular flowchart, including deletion or omission of a particular act, step, function, component or block. Moreover, the acts, steps, functions, components or blocks illustrated in a particular flowchart may be inter-mixed or otherwise inter-arranged with the acts, steps, functions, components or blocks illustrated in another flowchart in order to effectuate additional variations, modifications and configurations with respect to one or more synchronization and process restart implementations for purposes of practicing the teachings of the present patent disclosure.

It should be appreciated that the embodiments of the present disclosure can advantageously not only reduce the software code necessary for database synchronization in conventional router implementations but also facilitate NSR in a restarting IS-IS router wherein the routing process(es) may be componentized and run as separate modules in a suitable software architecture such that the necessity of a helping neighbor IS-IS router is eliminated. Accordingly, the amount of signaling necessary to synchronize the databases of all the routers (to achieve convergence) in a routing domain is significantly reduced. Furthermore, as the only data that may require retransmission is the data communicated during the transition period, exchanges of entire link state databases are avoided. As a consequence, inter-router database exchange can occur immediately such that any detrimental effects and associated routing instabilities caused by route removal and insertion in a network domain can be mitigated.

In the foregoing Detailed Description, functionalities of the various elements including components/blocks labeled or described as “module” or “process” or “processor” or “controller” or “computer” may be provided through the use of dedicated hardware as well as hardware capable of executing stored or preconfigured software. When provided by a processor, the functions may be provided by a single dedicated processor, by a single shared processor, or by a plurality of individual processors, some of which may be shared or distributed. Moreover, a “processor” or “controller” may include, without limitation, digital signal processor (DSP) hardware, ASIC hardware, read only memory (ROM), random access memory (RAM), and/or other storage media. In a further variation, the NSR and LSP database synchronization functionality set forth in the foregoing embodiments may be downloaded, uploaded, or otherwise imparted to an existing IS-IS router that does not already have a dedicated module (such as, e.g., the inter-process communication/synchronization module 209) so as to enhance its performance.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A method performed in a network element operating as an Intermediate System-to-Intermediate System (IS-IS) router having an active route processor (RP) module and a standby route processor (RP) module, the method comprising:
initiating an active IS-IS process on the active RP module for providing routing functionality, the active IS-IS process maintaining a first database associated with the active RP module with respect to the routing functionality;
initiating a standby IS-IS process on the standby RP module having a second database associated therewith, wherein the second database is populated based on synchronization with the first database; and
responsive to a control signal, restarting a new instance of the active IS-IS process on the active RP module and populating a new database associated with the new instance that is based on synchronization with the second database of the standby IS-IS process for continuing to provide the routing functionality.

2. The method as recited in claim 1, wherein the control signal is generated responsive to at least one of a network operator command input and detecting a failure condition encountered by the active IS-IS process.

3. The method as recited in claim 2, wherein the failure condition encountered by the active IS-IS process is at least one of a hardware failure, a software failure and a firmware failure.

4. The method as recited in claim 1, wherein each of the first database, the second database and the new database comprises at least one of a link state database, a forwarding database and an adjacency database.

5. The method as recited in claim 4, wherein the link state database comprises at least one of a Level 1 (L1) link state database and a Level 2 (L2) link state database.

6. The method as recited in claim 1, wherein the new instance of the active IS-IS process is restarted without sending a signal to adjacent IS-IS routers that the network element is restarting.

7. A network element configured to operate as an Intermediate System-to-Intermediate System (IS-IS) router, comprising:
an active route processor (RP) module supporting an active IS-IS routing process based on a first database associated therewith;
a standby route processor (RP) module supporting a standby IS-IS process based on a second database associated therewith;
a first synchronization module configured to facilitate synchronization of the first database of the active IS-IS process with the second database of the standby IS-IS process; and
a second synchronization module configured to facilitate synchronization of the second database of the standby IS-IS process with a new database on the active RP module when a new instance of the active IS-IS process is restarted on the active RP module responsive to a control signal, wherein the new instance of the active IS-IS process uses contents of the new database for continuing to maintain routing by the network element.

8. The network element as recited in claim 7, wherein the control signal is generated responsive to at least one of a network operator command input and detecting a failure condition encountered by the active IS-IS process.

9. The network element as recited in claim 8, wherein the failure condition encountered by the active IS-IS process is at least one of a hardware failure, a software failure and a firmware failure.

10. The network element as recited in claim 7, wherein each of the first database, the second database and the new database comprises at least one of a link state database, a forwarding database and an adjacency database.

11. The network element as recited in claim 10, wherein the link state database comprises at least one of a Level 1 (L1) link state database and a Level 2 (L2) link state database.

12. The network element as recited in claim 7, wherein the new instance of the active IS-IS process is restarted without sending a signal to adjacent IS-IS routers that the network element is restarting.

13. The network element as recited in claim 7, wherein the first and second synchronization modules are integrated as an inter-process communication module.

14. The network element as recited in claim 7, wherein the first synchronization module is adapted to perform bidirectional synchronization between the first and second databases.

15. The network element as recited in claim 7, wherein the second synchronization module is adapted to perform unidirectional synchronization from the second database to the new database.

16. A non-transitory computer-readable medium containing instructions stored thereon which, when executed by a computer system configured to operate as an Intermediate System-to-Intermediate System (IS-IS) router having an active route processor (RP) module and a standby route processor (RP) module, perform the acts:
initiating an active IS-IS process on the active RP module for providing routing functionality, the active IS-IS process maintaining a first database associated with the active RP module with respect to the routing functionality;
initiating a standby IS-IS process on the standby RP module having a second database associated therewith, wherein the second database is populated based on synchronization with the first database; and
restarting a new instance of the active IS-IS process on the active RP module, responsive to a control signal, and populating a new database associated with the new instance that is based on synchronization with the second database of the standby IS-IS process for continuing to provide the routing functionality.

17. The non-transitory computer-readable medium as recited in claim 16, wherein the control signal is generated responsive to at least one of a network operator command input and detecting a failure condition encountered by the active IS-IS process.

18. The non-transitory computer-readable medium as recited in claim 17, wherein the failure condition encountered by the active IS-IS process is at least one of a hardware failure, a software failure and a firmware failure.

19. The non-transitory computer-readable medium as recited in claim 16, wherein each of the first database, the second database and the new database comprises at least one of a link state database, a forwarding database and an adjacency database.

20. The non-transitory computer-readable medium as recited in claim 19, wherein the link state database comprises at least one of a Level 1 (L1) link state database and a Level 2 (L2) link state database.

21. The non-transitory computer-readable medium as recited in claim 16, wherein the new instance of the active IS-IS process is restarted without sending a signal to adjacent IS-IS routers that the IS-IS router is restarting.
